(19) United States
(12) Patent Application Publication
(10) Pub. No.: US 2024/0416435 A1
(43) Pub. Date: Dec. 19, 2024

(54) MILLING TOOL

(71) Applicants: Element Six (UK) Limited, Didcot, Oxfordshire (GB); Element Six Limited, County Clare (IE)

(72) Inventors: Brian GILROY, Didcot, Oxfordshire (GB); William Wayne LEAHY, Didcot, Oxfordshire (GB); Luiz Fernando PENNA FRANCA, Didcot, Oxfordshire (GB)

(21) Appl. No.: 18/708,303

(22) PCT Filed: Nov. 14, 2022
(86) PCT No.: PCT/EP2022/081794

§ 371 Date: May 8, 2024

(30) Foreign Application Priority Data
Nov. 16, 2021 (GB) 2116486.8

(51) Int. Cl. B23C 5/10

(52) U.S. Cl. CPC B23C 5/10

(57) ABSTRACT

A milling tool for milling a material is provided. The milling tool comprises a tool shank having an axis of rotation, and further comprises a tool head at one end thereof. The tool head comprises at least two tiers, each tier comprising a plurality of flutes extending circumferentially around the tool head. The tool head comprises superhard material and the tiers are axially displaced from each other and separated by a non-cutting portion of the tool head.

### FIELD OF THE INVENTION

This disclosure relates to an end mill tool (or cutter) for milling brittle materials. In particular, it relates to a tool for milling glass. More particularly, it relates to a micro end mill tool comprising polycrystalline diamond.

### BACKGROUND

Milling is a cutting process whereby a tool with multiple cutting surfaces is rotated to remove material from the surface of a work piece. Such tools, also known as cutters, come in all shapes and sizes, depending on the design of the workpiece. The tool has an elongate shank or handle, adjacent to a tool head which has the profiled cutting surfaces. The shank is mounted in a milling tool holder that is then mounted in the tool spindle of the machine and rotated.

End mill cutters are the most common form of milling cutter and they are available in a wide variety of heights, diameters and types. End mill cutters are used for machining the faces and sides of a workpiece. During a typical milling operation, the cutter moves perpendicularly to its axis of rotation, allowing it to remove material form the workpiece at the perimeter of the cutter. End mill cutters are used for slotting, profiling, contouring, counter-boring and reaming. The spiral-shaped cutting edges on the side of the end mill are known as ‘flutes’ and they provide an empty path for the cutting chips to escape from when the end mill is rotating in a workpiece.

End mill cutters are commonly made out of high-speed steel (i.e. cobalt steel alloys) or from tungsten carbide in a cobalt lattice. Carbide is considerably harder, more rigid, and more wear resistant than high-speed steel. However, carbide is brittle and tends to chip instead of wear. The choice of material depends on the material to be cut as well as on the maximum spindle speed of the machine.

The use of coatings increases the surface hardness of the tool. This enables greater tool life and cutting speed. Standard coatings include Titanium Nitride (TiN), Titanium Carbonitride (TiCN) and Aluminium Titanium Nitride (AITiN).

For workpieces made of harder materials, diamond electroplated tool heads are often used. In electroplated cutters, hundreds of individual diamond grits are embedded into a bonding agent on the surface of the tool head to provide numerous cutting surfaces and edges. However, a problem with electroplated milling tools is that the diamond grits are prone to pull-outs from the bonding agent, rendering the workpiece vulnerable to unwanted scratches from the rogue grits. Another problem is that diamond electroplated tools have a limited tool life, necessitating regular tooling changes and increasing the cost of production with every tool required.

It is an object of the invention to address the issue of grit pull-outs and tool life.

In micro end mill cutters, the outer diameter of the tool head is usually no more than 15 mm, and is typically in the range of 6 to 10 mm. Micro end mill cutters are deployed in milling operations during the construction of, for example, mobile phone handset shells. Handset shells are typically made from aluminium, polycarbonate or ceramic. One of the incumbent technologies is diamond electroplated micro end mill cutters.

It is a further object of the invention to provide a micro end mill tool suitable for use in milling mobile phone handset shells made from ceramics such as glass and the like.

### SUMMARY OF THE INVENTION

According to a first aspect, there is provided a milling tool for milling a material, the milling tool comprising a tool shank having an axis of rotation, and further comprising a tool head at one end thereof, the tool head comprising at least two tiers, each tier comprising a plurality of flutes extending circumferentially around the tool head. The tool head comprises superhard material and the tiers are axially displaced from each other and separated by a non-cutting portion of the tool head.

As an option, the superhard material comprises any of high pressure high temperature polycrystalline diamond, chemical vapour deposition diamond, and polycrystalline cubic boron nitride

As an alternative option, wherein the superhard material comprises polycrystalline chemical vapour deposition diamond coated on a cemented carbide substrate

The material to be milled optionally comprises any of glass, ceramic, polymer, composites, metallic materials and metal-ceramic composites.

As an option, the milling tool comprises at least three tiers.

The tool head is optionally cylindrical and non-tubular.

As an option, the superhard material is monolithic polycrystalline diamond. As an alternative option, the superhard material is polycrystalline diamond adjoining a carbide backing portion.

Optionally, at least one tier is configured for operations selected from any of roughing, semi-finishing and milling.

Two or more tiers are optionally configured for the same milling operation.

As an option, each tier is configured differently to the remaining tiers.

As an option, at least one tier has a different diameter to the other tiers.

The tool head optionally has an overall height of no more than 12 mm.

The tool head optionally has an overall height of no less than 0.5 mm.

The milling tool is optionally a micro end mill tool having an outer diameter selected from any of no more than 15 mm, no more than 10 mm and no less than 6 mm.

As an option, the tool shank comprises cemented carbide.

The tool shank optionally further comprises a conduit for carrying compressed air to the tool head to eject waste milling media.

According to a second aspect, there is provided a method of making a milling tool head, the method comprising the steps:
a. providing a disc blank comprising a superhard material;
b. machining at least one precursor tool head from the disc;
c. forming a tier containing a plurality of flutes in the precursor tool head using a laser,
d. repeating step c as required, to thereby form a tool head comprising at least two tiers, each tier comprising a plurality of flutes extending circumferentially around the tool head, and wherein the tool head comprises the superhard material, and wherein the tiers are axially displaced from each other and separated by a non-cutting portion of the tool head.

As an option, the superhard material comprises any of high pressure high temperature polycrystalline diamond, chemical vapour deposition diamond, and polycrystalline cubic boron nitride.

According to a third aspect, there is provided a method of making a milling tool head, the method comprising the steps of:
a. providing a disc blank;
b. machining at least one precursor tool head from the disc;
c. forming a tier containing a plurality of flutes in the precursor tool head using a laser,
d. repeating step c as required, to thereby form a tool head comprising at least two tiers, each tier comprising a plurality of flutes extending circumferentially around the tool head, and wherein the tool head comprises the superhard material, and wherein the tiers are axially displaced from each other and separated by a non-cutting portion of the tool head; and
e. depositing polycrystalline diamond on the plurality of flutes using chemical vapour deposition.

As an option, the chemical vapour deposition of polycrystalline diamond comprises hot filament chemical vapour deposition.

### BRIEF DESCRIPTION OF THE DRAWINGS

The invention will now be more particularly described, by way of example only, with reference to the accompanying drawings, in which:

FIG. 1 is a perspective view of a tool in accordance with the invention, with a first embodiment of a tool head;

FIG. 2 is a front view of the tool of FIG. 1;

FIG. 3 is an enlarged view of portion X from FIG. 2;

FIG. 4 is a front view of a second embodiment of a tool head;

FIG. 5 is a front view of a third embodiment of a tool head;

FIG. 6 is a front view of a fourth embodiment of a tool head;

FIG. 7 is a front view of a fifth embodiment of a tool head;

FIG. 8 is an annotated version of the tool head of FIGS. 5 and/or 6;

FIG. 9 is another annotated version of the tool head of FIGS. 5 and/or 6;

FIG. 10 is a schematic indicating the lateral cross-section of the flutes in the tool head; and

FIG. 11 is a schematic indicating the cutting action of the flutes during use.

Throughout the embodiments, similar parts are denoted by the same reference numeral and a further description is omitted for brevity.

### DETAILED DESCRIPTION

The following description refers to a tool head comprising a superhard material. In the examples, polycrystalline diamond (PCD) is referred to, but this is by way of example only. For milling ferrous materials, polycrystalline cubic boron nitride is preferred. Furthermore, while PCD may be used, other forms of synthetic diamond may be used, such as chemical vapour deposition (CVD) diamond.

Furthermore, the following description refers to milling glass by way of example, but it will be appreciated that the same tool configuration can be used for milling other types of material. A non-limiting list of materials that can be milled includes glass, ceramic, polymer, composites, metallic materials and metal-ceramic composites.

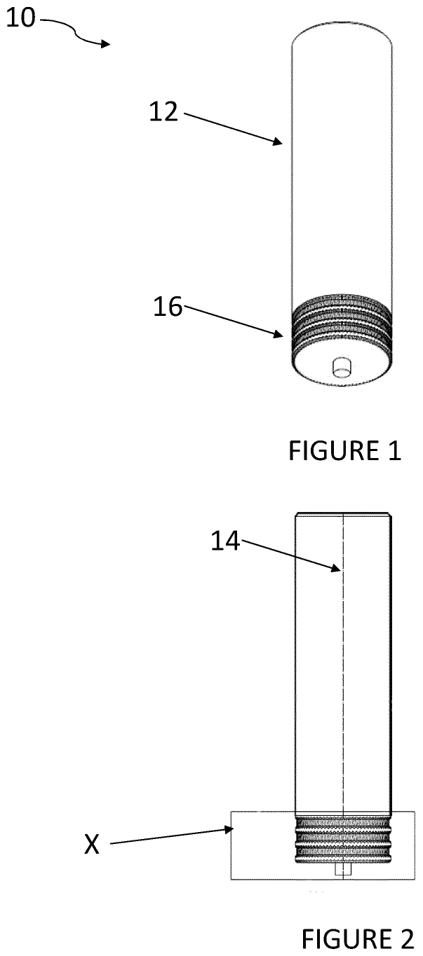

Referring firstly to FIGS. 1 to 3, a milling tool is indicated generally at 10. The tool comprises a tool shank 12 having a longitudinal axis of rotation 14, and further comprises a tool head 16 at one end of the shank 12. The tool head 16 comprises at least one tier 18 (i.e. a stage or a level), the or each tier comprising a plurality of flutes 20 extending circumferentially around the tool head 16. In any one tier 18, all the flutes are in a band, i.e. they are in axial alignment with each other. Additional tiers are axially displaced with regards to the initial tier. A tool with multiple tiers therefore has tiers that are co-axially aligned and adjacent to each other.

The tool head 16 in this example comprises polycrystalline diamond (PCD).

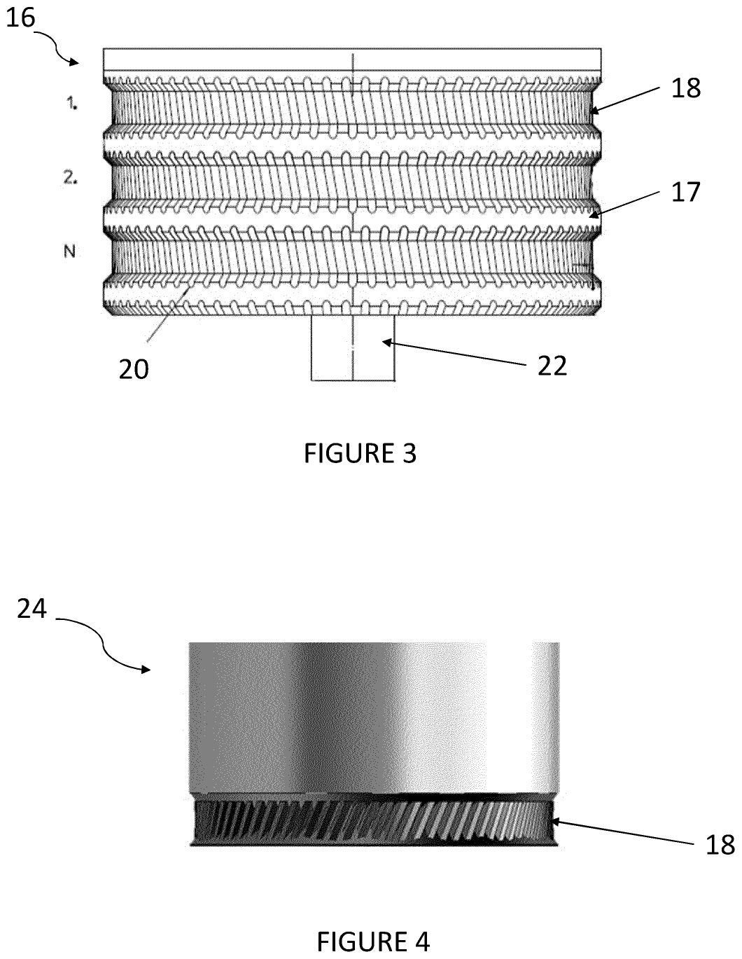

FIG. 3 shows a first embodiment of a tool head 16. Tool head 16 comprises three tiers 18a, 18b, 18c and a notch element 22. Tier 18a corresponds to the tier closest to the shank, tier 18c corresponds to the tier furthest away from the shank, and tier 18b corresponds to the tier axially intermediate tiers 18a and 18c. Each tier 18 comprises a plurality of flutes. The flutes 20 are provided in an outer surface of the tool head. The flutes 20 extend around the entire circumference of the tool head 16. The flutes 20 are created in the outer surface using a laser which initially ablates unwanted material, thereby creating recesses between precursor flutes 20, and subsequently shapes the precursor flutes according to a desired profile into a final flute 20 configuration. More detail on the flutes 20 is provided later.

Each tier 18 is separated from an adjacent tier 18 by a non-cutting portion 17 of the tool head 16.

The notch element 22 is configured to carve a correspondingly shaped notch into a workpiece, for example a microphone aperture in a mobile phone handset shell. As an example only, the notch element 22 may have a diameter of up to 1 mm and a height of up to 1 mm. The notch element 22 is entirely optional and may be omitted.

In FIG. 4, an exemplary tool head 24 is shown, although this is out of scope of the invention as claimed. In this example, only a single tier 18a is provided.

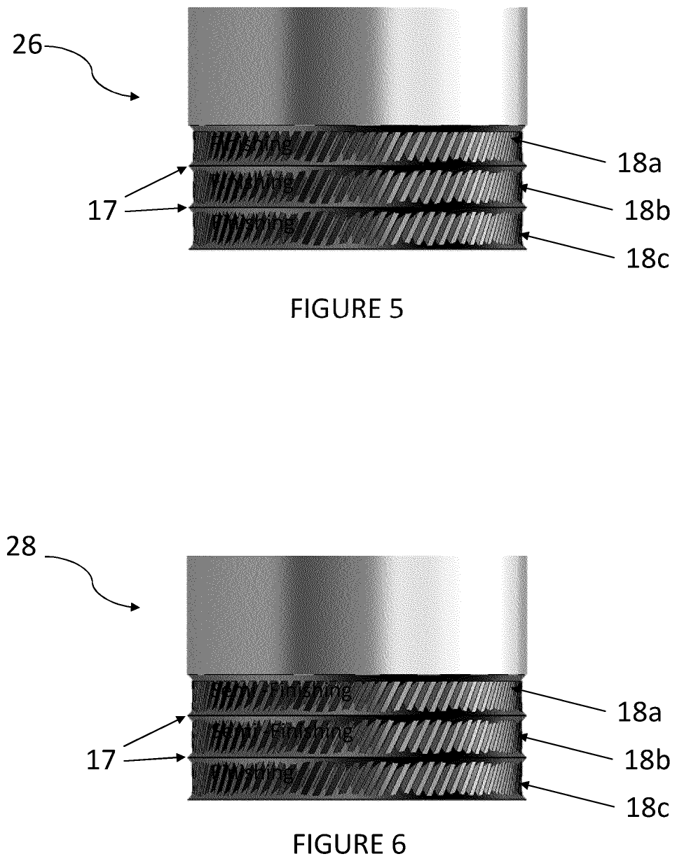

Turning now to FIG. 5, a further embodiment of a tool head 26 is shown. In this embodiment, three tiers 18a, 18b, 18c are again provided, each separated from the adjacent tiers by a non-cutting portion. Each of the three tiers 18a, 18b and 18c is configured for finishing operations. However, the three tiers may all be configured for roughing, or alternatively they may all be configured for semi-finishing. The advantage of the configuration where all tiers are configured for the same milling operation is that it extends the service life of the tool by a factor of ‘n’ where ‘n’ is the quantity of tiers. As the first tier, whichever one it might be that is used first, wears out, then the spindle can be extended or retracted as appropriate, to move one of the other tiers into position. This is repeated as and when required, depending on the quantity of tiers 18 provided. Since the wear rate is the same for all three tiers, the operational life of the tool is maximised.

In FIG. 6, a further embodiment of a tool head 28 is shown. In this embodiment, three tiers 18a, 18b, 18c are again provided, each separated from the adjacent tiers by a non-cutting portion. The first and second tiers 18a, 18b respectively, are configured for semi-finishing milling operations. Only the third tier 18c is configured for finishing milling operations. One of the advantages of this configuration is that, unlike the example given in FIG. 5, it does not require the additional tool change between milling operations. The tool is multi-functional and can be used for more than one specific milling operation, thereby reducing machine downtime and maximising operational equipment effectiveness. A tool configured for more than one type of milling operation may be considered to be a ‘multi-tool’.

The inventors have found that the tier furthest away from the shank 12 experiences the greatest forces and greatest moments during use and therefore in principle would wear away at the greatest rate. With higher moments also comes less stability and higher vibrations. It is important to consider that the wear morphology for the different milling operations varies too. For example, during finishing, wear tends to be abrasive wear exclusively, whereas during semi-finishing, chipping also occurs. These factors can all contribute towards premature failure of the tool. Therefore, it is important to consider the relative positioning of tiers 18 and their configuration for specific milling operations.

It is preferable to situate the tier configured for finishing operations furthest away from the shank because finishing operations require less forces and produce less wear. By placing the two tiers configured for semi-finishing closer to the shank, the wear rate across the three tiers 18 is balanced out and the life of the three tiers 18 is maximised. Also, by having a greater quantity of tiers for semi-finishing and roughing, since the probability of failure from chipping is higher from these milling operations, the tool provides operational redundancy and enables swift substitution with follow-on tiers, thereby minimising machine downtime.

Since a finishing operation produces half as much wear as a semi-finishing process, a tier configured for finishing will have a life that is approximately twice as long as a tier configured for semi-finishing. Having twice as many tiers for semi-finishing milling operations as tiers for finishing operations is therefore an optimum proportion. As an example, for a tool with six tiers in total, four of those tiers would be for semi-finishing and two of those tiers would be for finishing. To continue the example, a tool with twelve tiers in total, eight of those tiers would be for semi-finishing and four of those tiers would be for finishing.

In another embodiment, not shown, the tiers 18 may all be configured exclusively for roughing operations.

Since a tier configured for roughing produces yet more wear than a tier configured for semi-finishing, the proportion of tiers configured for roughing will be at least double the quantity of tiers configured for semi-finishing, typically three to four times. For example, a single tool configured for all three milling operations may have nine tiers in total, may have six tiers for roughing, two tiers for semi-finishing, and one tier for finishing.

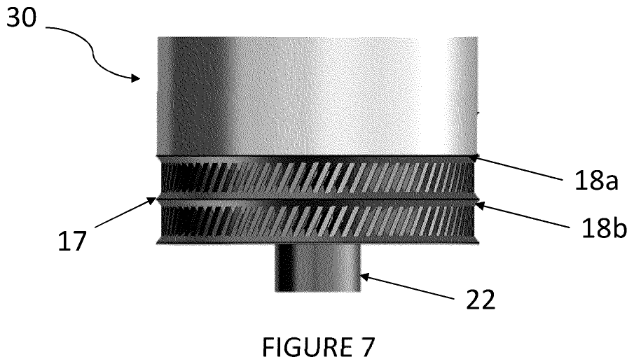

Turning now to FIG. 7, another embodiment of a tool head 30 is shown. In this embodiment, two tiers 18a and 18b are provided, each separated from the adjacent tiers by a non-cutting portion, and the tool head is provided with a notching element 22.

The tool shank 12 comprises cemented metal carbide, for example tungsten carbide, although other suitable materials are envisaged. Optionally, the tool shank 12 comprises a conduit (not shown) for carrying compressed air to the tool head to eject waste milling media from the flutes.

The tool head 16 is cylindrical and non-tubular. The tool head 16 in one example comprises a solid, monolithic PCD block. In this context, ‘monolithic’ means that the PCD has been sintered in a single piece in a single sintering operation. In the examples shown above, a PCD portion 32 is sinter-joined to a carbide backing layer 34, though this need not be the case and the carbide backing layer 34 may be omitted. The tiers 18 are provided in the PCD portion 32 of the tool head, and not in the carbide backing layer 34. The carbide backing layer 34 facilitates attachment to the tool shank 12, which can be achieved using any reasonable means.

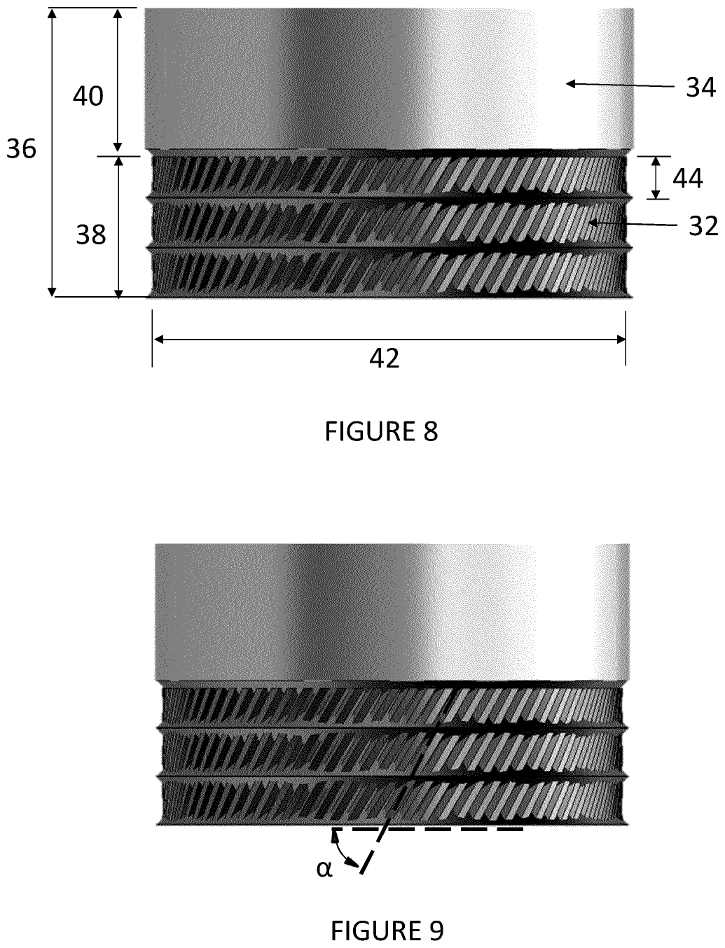

Referring to FIG. 8, an overall height of the tool head 16 is indicated at 36, and it is the sum of the height 38 of the PCD portion 32 and the height 40 of the carbide portion 34 if a carbide backing layer 34 is included (otherwise, it is only the height 38 of the PCD portion 32). Optionally, the height 36 of the tool head 16 is 0.5 mm to 12 mm. Optionally, the height 36 of the tool head 16 is 1 to 10 mm. Optionally, the height 36 of the tool head 16 is 6 mm. The height 32 of the PCD portion 32 may be in the range of 0.5 to 6 mm, for example 2.5 mm. It is envisaged that the height of the tool head may be in the order of nanometres (i.e. <100 nm), for example an overall height of 50 to 95 nm, or smaller. Optionally, the height 36 of the tool head 16 is no more than 12 mm.

The outer diameter of the tool 10 is indicated at 42 and is the largest, outermost, diameter of any of the tiers 18 and the shank 12. Individual tiers 18 may have different diameters to each other, depending, for example on which milling operation they are configured for. Optionally, all tiers 18 will have the same diameter.

Preferably, the tool 10, 24, 26, 28, 30 is a micro end mill tool which has an outer diameter of no more than 15 mm. Optionally, the outer diameter 42 of the tool is 10 mm. In one example of a micro end mill tool, the overall height of the tool, including tool shank 12 and tool head 16 may be around 200 mm.

The height 44 of each tier 18 (measured axially, the same as the previous height measurements) depends on the quantity of tiers 18 and the height 38 of the PCD, regardless of whether it is backed or unbacked with carbide backing layer 34. As an example, for a tool head 16 comprising a PCD portion 32 backed with a carbide layer 34 which has a tool head 36 height of 6 mm, the height 38 of the PCD portion is 2.5 mm, and for three tiers, the height 44 of each tier is 0.6 to 0.7 mm.

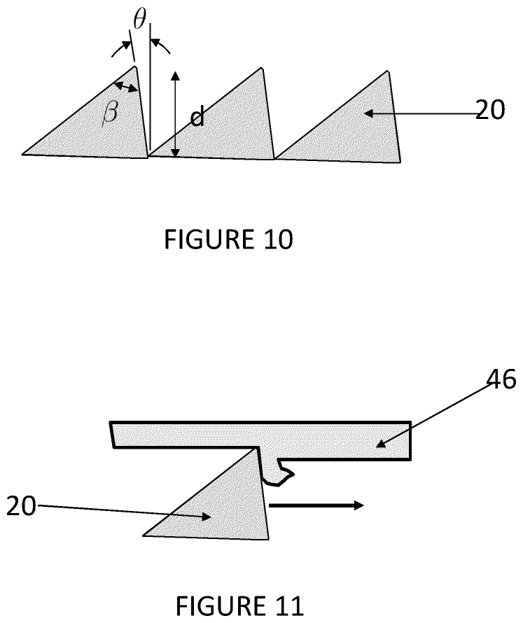

Referring to FIGS. 9, 10 and 11, each flute 20 has a triangular lateral cross-section. Various flute parameters influence certain factors. The helix angle, a and the flute depth, d affect the amount of clogging with waste debris that occurs between flutes during milling, and therefore the cleaning of the tool head 16. The helix angle, α, also affects tool stability. The flute angle β, rake (cutting) angle θ, and the quantity of flutes, N, have a direct effect on the surface finish, subsurface damage, tool performance (cutting forces) and tool life. FIG. 11 indicates schematically how each flute may cut the workpiece 46 as the tool advances laterally in the direction of the arrow during use.

The aforementioned parameters, helix angle, α, flute angle β, rake (cutting) angle θ, quantity of flutes, N and flute depth, d, within the or each tier are optimised depending on whether the aim of the milling operation is for roughing, semi-finishing or finishing in the context of milling glass or other similar brittle material. A roughing milling operation is generally intended to prepare the surface of the workpiece before the finishing operation. The purpose is to bring the dimension to a “rough” size of the final dimension. How this looks may be of little importance since the main aim is to clear away relatively large amounts of material quickly. Roughing will likely require a greater flute angle β than the other operations in order to provide a more substantial flute body to deal with the higher forces. This will reduce the quantity of flutes that can be fitted into a finite space, and therefore the quantity of flutes in a tier. A semi-finishing milling operation is typically the next stage after roughing. The purpose is to achieve a dimension even closer to the final dimension. A finishing milling operation is the final stage of machining a workpiece. A minimal quantity of workpiece material is removed, the workpiece is machined to size, the final dimension is obtained and sometimes the surface is further refined too.

One exemplary way to make one of the tool heads described is as follows: a typically circular blank shaped like a disc comprising superhard material such as PCD or PCBN is provided. At least one precursor tool head is machined from the disc. The quantity of precursor tool heads available depends on the diameter of the blank, the useable area devoid of defects and the outer diameter of the tool. The blank may be backed with a carbide backing layer or alternatively unbacked, or ‘freestanding’. The depth of the blank determines the depth of the tool head 16. A plurality of flutes is then formed in the precursor tool head using a laser. The flutes are arranged in axially adjacent tiers. This latter step is then repeated as often as required, thereby forming a tool head comprising at least one tier, wherein the or each tier comprises a plurality of flutes extending circumferentially around the tool head.

An alternative way to make one of the tool heads described is as follows: a cemented carbide disc blank is provided and a precursor tool head is machined from the disc. A tier containing a plurality of flutes is formed in the precursor tool head using a laser. This step is repeated as required, to form a tool head comprising at least two tiers, each tier comprising a plurality of flutes extending circumferentially around the tool head, and wherein the tool head comprises the superhard material, and wherein the tiers are axially displaced from each other and separated by a non-cutting portion of the tool head. Finally, polycrystalline diamond is deposited on the plurality of flutes using chemical vapour deposition. Typically, hot filament CVD is used, but other forms of CVD such as microwave plasma CVD may be used. A final finishing operating may be required on the deposited diamond layer on the flutes.

In summary, the inventors have devised a milling tool that maximises tool life and improves the cost/benefit performance. This is done through the use of superhard material such as PCD, CVD diamond or PCBN, and in particular through a tiered approach to milling operations.

While this invention has been particularly shown and described with reference to embodiments, it will be understood by those skilled in the art that various changes in form and detail may be made without departing from the scope of the invention as defined by the appended claims. For example, although some of the above examples include a monolithic PCD portion, in a less preferred embodiment, the tool head may comprise two or more PCD segments stacked side by side adjacent to each other, each segment forming one or more of said tiers. In such an arrangement, the PCD segments maybe annular, aligned coaxially with the axis of rotation, and mounted about a hub extending from the tool shank.

1. A milling tool for milling a material, the milling tool comprising a tool shank having an axis of rotation, and further comprising a tool head at one end thereof, the tool head comprising at least two tiers, each tier comprising a plurality of flutes extending circumferentially around the tool head, and wherein the tool head comprises superhard material and wherein the tiers are axially displaced from each other and separated by a non-cutting portion of the tool head.

2. The milling tool according to claim 1, wherein the superhard material comprises any of high pressure high temperature polycrystalline diamond, chemical vapour deposition diamond, and polycrystalline cubic boron nitride.

3. The milling tool according to claim 1, wherein the superhard material comprises polycrystalline chemical vapour deposition diamond coated on a cemented carbide substrate.

4. (canceled)

5. The milling tool as claimed in claim 1, comprising at least three tiers.

6. The milling tool as claimed in claim 1, wherein the tool head is cylindrical and non-tubular.

7. The milling tool as claimed in claim 1, in which the superhard material is monolithic polycrystalline diamond.

8. The milling tool as claimed in claim 1, wherein the superhard material is polycrystalline diamond adjoining a carbide backing portion.

9. The milling tool as claimed in claim 1, in which at least one tier is configured for operations selected from any of roughing, semi-finishing and milling.

10. The milling tool as claimed in claim 1, in which two or more tiers are configured for the same milling operation.

11. The milling tool as claimed in claim 1, in which each tier is configured differently to the remaining tiers.

12. The milling tool as claimed in claim 1, in which at least one tier has a different diameter to the other tiers.

13. The milling tool as claimed in claim 1, in which the tool head has an overall height of no more than 12 mm.

14. The milling tool as claimed in claim 13, in which the tool head has an overall height of no less than 0.5 mm.

15. The milling tool as claimed in claim 1, which is a micro end mill tool having an outer diameter selected from any of no more than 15 mm, no more than 10 mm and no less than 6 mm.

16. The milling tool as claimed in claim 1, in which the tool shank comprises cemented carbide.

17. The milling tool as claimed in claim 1, wherein the tool shank further comprises a conduit for carrying compressed air to the tool head to eject waste milling media.

18. A method of making a milling tool head, the method comprising the steps:
a. providing a disc blank comprising a superhard material;
b. machining at least one precursor tool head from the disc;
c. forming a tier containing a plurality of flutes in the precursor tool head using a laser,
d. repeating step c as required, to thereby form a tool head comprising at least two tiers, each tier comprising a plurality of flutes extending circumferentially around the tool head, and wherein the tool head comprises the superhard material, and wherein the tiers are axially displaced from each other and separated by a non-cutting portion of the tool head.

19. The method according to claim 18, wherein the superhard material comprises any of high pressure high temperature polycrystalline diamond, chemical vapour deposition diamond, and polycrystalline cubic boron nitride.

20. A method of making a milling tool head, the method comprising the steps of:
a. providing a disc blank;
b. machining at least one precursor tool head from the disc;
c. forming a tier containing a plurality of flutes in the precursor tool head using a laser,
d. repeating step c as required, to thereby form a tool head comprising at least two tiers, each tier comprising a plurality of flutes extending circumferentially around the tool head, and wherein the tool head comprises the superhard material, and wherein the tiers are axially displaced from each other and separated by a non-cutting portion of the tool head; and
e. depositing polycrystalline diamond on the plurality of flutes using chemical vapour deposition.

21. The method according to claim 20, wherein the chemical vapour deposition of polycrystalline diamond comprises hot filament chemical vapour deposition.
